(19) United States
(12) Patent Application Publication
(10) Pub. No.: US 2025/0178118 A1
(43) Pub. Date: Jun. 5, 2025

(54) DISSIMILAR-MATERIAL JOINED BODY, METHOD FOR PRODUCING DISSIMILAR-MATERIAL JOINED BODY, AND STUD-EQUIPPED ALUMINUM MEMBER

(71) Applicant: KABUSHIKI KAISHA KOBE SEIKO SHO (KOBE STEEL, LTD.), Kobe-shi (JP)

(72) Inventors: Yoshihaya IMAMURA, Tokyo (JP); Takumi NAKAHARA, Yamaguchi (JP); Narikazu HASHIMOTO, Yamaguchi (JP); Chieko IMAI, Kanagawa (JP)

(73) Assignee: KABUSHIKI KAISHA KOBE SEIKO SHO (KOBE STEEL, LTD.), Kobe-shi (JP)

(21) Appl. No.: 18/843,923

(22) PCT Filed: Mar. 1, 2023
(86) PCT No.: PCT/JP2023/007701

§ 371 Date: Sep. 4, 2024

(30) Foreign Application Priority Data
Mar. 24, 2022 (JP) 2022-033876
Aug. 24, 2022 (JP) 2022-133579

(51) Int. Cl. B23K 11/20; B23K 11/00; B23K 101/00; B23K 103/20

(52) U.S. Cl. CPC B23K 11/20; B23K 11/0053; B23K 11/0066; B23K 2101/006; B23K 2103/20

(57) ABSTRACT

A dissimilar-material joined body is obtained by fusion joining a steel material and a stud-equipped aluminum member obtained by attaching a steel stud member to an aluminum material. The stud member includes a head portion and a shaft portion. The shaft portion penetrates the aluminum material in a plate thickness direction, protrudes from the aluminum material, and is formed with, at a tip end of the protruding shaft portion. An expanded diameter portion expands radially outward. A back side surface of the head portion that faces the aluminum material is clinched to the aluminum material. The head portion and the steel material are fusion welded to each other with a gap having a desired interval formed between the aluminum material and the steel material.

### TECHNICAL FIELD

The present invention relates to a dissimilar-material joined body, a method for producing the dissimilar-material joined body, and a stud-equipped aluminum member.

### BACKGROUND ART

For example, in a vehicle such as an automatic vehicle, structural members called side sills are provided along a front and rear direction at both side portions of a lower portion of a vehicle body. Some of the side sills include a reinforcement member composed of an aluminum extruded material having a closed sectional structure in order to improve energy absorption properties. In such a side sill, it is necessary to dissimilarly join the reinforcement member composed of an aluminum extruded material to a steel material such as a steel plate or a mold steel which is originally widely used as a vehicle body of an ordinary automatic vehicle.

Patent Literature 1 discloses a technique of joining a plate material containing iron as a main component and a plate material containing aluminum as a main component by driving a self piercing rivet (SPR) from a plate material side containing aluminum as a main component and causing a protrusion portion of the self piercing rivet to expand in the plate material containing iron as a main component.

Patent Literature 2 discloses that, in a dissimilar metal joined body of a light alloy plate material and a steel plate material, a convex portion of the light alloy plate material that protrudes toward the steel plate material is spot welded to the steel plate material, electrodeposition coating is applied to a gap formed by the convex portion, and the gap is further sealed.

Further, Patent Literature 3 discloses a joint structure in which a first member and a second member made of different materials are disposed apart from each other by a rivet. In this joint structure, in at least one of the first member and the second member, a resin is provided on a surface opposite to a facing side to prevent penetration of moisture and prevent occurrence of rust, erosion, and electric erosion.

### CITATION LIST

### Patent Literature

Patent Literature 1: JP2008-267594A
Patent Literature 2: JP2012-000652A
Patent Literature 3: JP2016-148447A

### SUMMARY OF INVENTION

### Technical Problem

The technique described in Patent Literature 1 is generally adopted for joining dissimilar materials, but since self piercing riveting is a joining method in which a hole is drilled and shaped in the aluminum material and the steel material during joining, it is necessary to apply a large load (several tons). This causes distortion in the aluminum material and the steel material around a joined portion, resulting in loss of flatness.

In addition, in the technique described in Patent Literature 2, since a gap is formed between the light alloy plate material and the steel plate material by the convex portion to be spot welded, a dimension of the gap is likely to vary depending on mechanical properties of the materials or processing accuracy (convex processing). Therefore, it is difficult to stably perform electrodeposition coating on the gap.

The technique described in Patent Literature 3 makes it possible to form a gap between members with high accuracy. However, the gap (a separation distance) between the members needs to be set large to allow the resin to flow and fill the gap, which causes the moment to concentrate, resulting in stress concentration and decreased strength. Accordingly, a reinforcement member is required to be disposed in the formed gap between the members.

The present invention has been made to solve the above problems, and an object of the present invention is to provide a dissimilar-material joined body in which dissimilar materials are firmly joined to each other and excellent erosion resistance can be secured, a method for producing the dissimilar-material joined body, and a stud-equipped aluminum member.

### Solution to Problem

The present invention includes the following configurations.
(1) A dissimilar-material joined body, which is obtained by fusion joining a steel material and a stud-equipped aluminum member obtained by attaching a steel stud member to an aluminum material, in which
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material, and
the head portion and the steel material are fusion welded to each other with a gap having a desired interval formed between the aluminum material and the steel material.
(2) A dissimilar-material joined body, which is obtained by fusion joining a steel material and a stud-equipped aluminum member obtained by attaching a steel stud member to an aluminum material, in which
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material, and
the tip end of the shaft portion and the steel material are fusion welded to each other with a gap having a desired interval formed between the aluminum material and the steel material.
(3) A stud-equipped aluminum member, which is obtained by attaching a steel stud member that is to be fusion welded to a steel material to an aluminum material, in which
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material,
a protrusion portion protruding in an axial direction of the shaft portion is provided on a front side surface of the head portion opposite to the shaft portion, and
the head portion and the steel material are fusion welded to each other with a gap having a desired interval formed between the aluminum material and the steel material.
(4) A stud-equipped aluminum member, which is obtained by attaching a steel stud member that is to be fusion welded to a steel material to an aluminum material, in which
the stud member includes a head portion and a shaft portion,
the shaft portion penetrates the aluminum material in a plate thickness direction and protrudes from the aluminum material,
a back side surface of the head portion that faces the aluminum material is clinched to the aluminum material,
a concave portion recessed axially inward is formed at a tip end of the shaft portion, and
the tip end of the shaft portion and the steel material are fusion welded to each other with a gap having a desired interval formed between the aluminum material and the steel material.
(5) A method for producing a dissimilar-material joined body, the dissimilar-material joined body being obtained by joining a steel material and a stud-equipped aluminum member obtained by attaching a steel stud member to an aluminum material, the method including:
driving a shaft portion of the stud member including a head portion and the shaft portion into the aluminum material so that a tip end of the shaft portion penetrates the aluminum material to protrude from the aluminum material, an expanded diameter portion that expands radially outward is formed at the protruding tip end of the shaft portion, and a back side surface of the head portion that faces the aluminum material is clinched to the aluminum material; and
fusion welding the shaft portion and the steel material while overlapping the tip end of the shaft portion and the steel material and forming a gap having a desired interval between the aluminum material and the steel material.
(6) A method for producing a dissimilar-material joined body, the dissimilar-material joined body being obtained by joining a steel material and a stud-equipped aluminum member obtained by attaching a steel stud member to an aluminum material, the method including:
driving a shaft portion of the stud member including a head portion and the shaft portion into the aluminum material so that a tip end of the shaft portion penetrates the aluminum material in a plate thickness direction to protrude from the aluminum material, an expanded diameter portion that expands radially outward is formed at the protruding tip end of the shaft portion, and a back side surface of the head portion that faces the aluminum material is clinched to the aluminum material; and
fusion welding the head portion and the steel material while overlapping the head portion and the steel material and forming a gap having a desired interval between the aluminum material and the steel material.

### Advantageous Effects of Invention

According to the present invention, dissimilar materials are firmly joined to each other, and excellent erosion resistance can be ensured.

### BRIEF DESCRIPTION OF DRAWINGS

FIG. 1 is a perspective view of a dissimilar-material joined body according to a first configuration example.

FIG. 2 is a sectional view taken along a direction orthogonal to a longitudinal direction at a joined portion between a flange portion and a steel material of the dissimilar-material joined body according to the first configuration example.

FIG. 3 is a sectional view taken along the longitudinal direction at the joined portion between the flange portion and the steel material of the dissimilar-material joined body according to the first configuration example.

FIG. 4 is a cross sectional view of the joined portion between the flange portion and the steel material of the dissimilar-material joined body to which electrodeposition coating is applied.

FIG. 5 is a sectional view taken along an arrangement direction of stud members which illustrates a clinching step of joining the stud members to the flange portion.

FIG. 6 is a sectional view taken along the arrangement direction of the stud members in the flange portion to which the stud members are joined.

FIG. 7 is a perspective view of an aluminum extruded material in which the stud members are clinched to the flange portion.

FIG. 8 is a sectional view of a welded portion which illustrates a spot welding step of welding the stud member to the steel material.

FIG. 9 is a cross sectional view of a joined portion between the flange portion and the steel material which illustrates another configuration example.

FIG. 10 is a front view of the dissimilar-material joined body which illustrates another configuration example.

FIG. 11 is a sectional view taken along a direction orthogonal to a longitudinal direction at a joined portion between a flange portion and a steel material of a dissimilar-material joined body according to a second configuration example.

FIG. 12 is a sectional view taken along the longitudinal direction at the joined portion between the flange portion and the steel material of the dissimilar-material joined body according to the second configuration example.

FIG. 13 is a sectional view of a welded portion which illustrates a spot welding step of welding a stud member to the steel material.

FIG. 14 is a cross sectional view of a joined portion between a flange portion and a steel material which illustrates another configuration example.

FIG. 15 is a cross sectional view of the flange portion at a clinched portion of a stud member which illustrates the another configuration example.

FIG. 16 is a sectional view of a welded portion which illustrates a spot welding step of welding the stud member to the steel material.

FIG. 17 is a sectional view illustrating a step of forming an expanded diameter portion in a shaft portion of the stud member by a pressing step in which a die and a punch are used.

FIG. 18A is a sectional view of a stud member in which a protruding piece is formed on a part of a tip end of a shaft portion including a concave portion.

FIG. 18B is a plan view of the stud member illustrated in FIG. 18A as viewed from below.

FIG. 19A is a view illustrating a forming procedure of the protruding piece.

FIG. 19B is a view illustrating a forming procedure of the protruding piece.

FIG. 19C is a view illustrating a forming procedure of the protruding piece.

FIG. 20 is a view illustrating a groove structure formed in an upper portion of a die illustrated in FIGS. 19A to 19C.

FIG. 21 is a sectional view illustrating a step of laser welding the stud member and the steel material.

FIG. 22 is a sectional view illustrating a step of laser welding a stud member having a through hole and the steel material.

FIG. 23 is a sectional view illustrating an electrodeposition coating region when a head portion of the stud member is joined to the steel material.

FIG. 24 is a perspective view of a stud member including projections as viewed from a head portion side.

FIG. 25 is a perspective view of the stud member illustrated in FIG. 24 as viewed from a shaft portion side.

FIG. 26 is a sectional view of the stud member taken along line XXVI-XXVI in FIG. 24.

FIG. 27A is a sectional view illustrating a state in which the stud member is positioned at an emboss of the steel plate.

FIG. 27B is a sectional view illustrating a state in which the stud member is positioned on a protrusion provided on the steel plate.

FIG. 28 is a sectional view of a stud member having another configuration.

FIG. 29A is a perspective view of a stud member in which a protrusion portion protruding axially is provided in a concave portion at a tip end of a shaft portion.

FIG. 29B is a sectional view of the stud member taken along line XXIX-IX XXIX in FIG. 29A.

FIG. 30A is a perspective view of a stud member in which a protrusion portion protruding axially is provided in a concave portion at a tip end of a shaft portion.

FIG. 30B is a sectional view of the stud member taken along line XXX-XXX in FIG. 30A.

FIG. 31 is a sectional view taken along an arrangement direction of stud members at a joined portion between a flange portion of a steel material of a dissimilar joint reinforcement member which illustrates another configuration example.

### DESCRIPTION OF EMBODIMENTS

Hereinafter, embodiments of the present invention will be described in detail with reference to the drawings.

### First Configuration Example

First, a dissimilar-material joined body according to a first configuration example will be described.

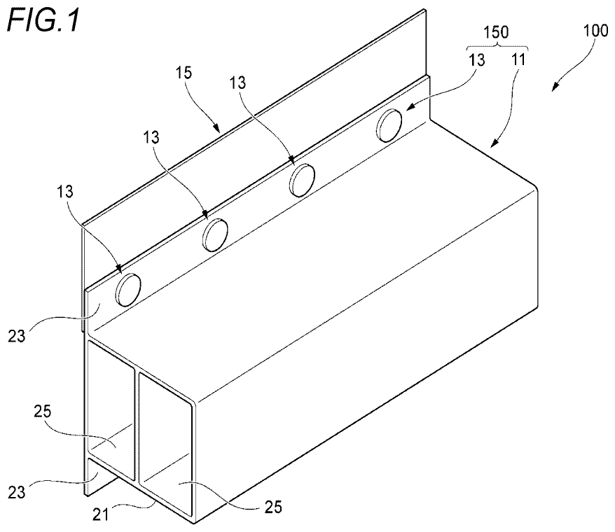

FIG. 1 is a perspective view of a dissimilar-material joined body 100 according to the first configuration example.

As illustrated in FIG. 1, the dissimilar-material joined body 100 according to the first configuration example is a dissimilar joint reinforcement member obtained by fusion joining a steel material 15 and a stud-equipped aluminum member 150 obtained by attaching steel stud members 13 to an aluminum extruded material 11 that is an aluminum material. That is, the aluminum extruded material 11 and the steel material 15 are joined by the stud member 13. The dissimilar-material joined body 100 is provided in a vehicle such as an automatic vehicle as a structural member called a side sill, for example, and is assembled to both side portions of a lower portion of a vehicle body along a front and rear direction (a traveling direction) of the vehicle.

The aluminum extruded material 11 is formed of a hollow extruded material made of aluminum or an aluminum alloy having a rectangular hollow section with a thickness (a plate thickness) of about 2 mm to 5 mm. The aluminum extruded material 11 includes a main body portion 21 and flange portions 23. The main body portion 21 is formed to have a hollow sectional shape having two rectangular hollow portions 25. The flange portion 23 is formed in a plate shape, protrudes from an outer shape of the main body portion 21, and is provided along a longitudinal direction of the extruded material. The flange portion 23 protrudes to both sides on one end side in a sectional view orthogonal to the longitudinal direction of the main body portion 21. The aluminum extruded material 11 may include the main body portion 21 having one hollow portion 25, or may include the main body portion 21 having three or more hollow portions 25. The aluminum extruded material 11 may include one flange portion 23.

The aluminum alloy used for the aluminum extruded material 11 is an aluminum alloy such as 5000 series, 6000 series, or 7000 series according to the JIS or AA standards, because the aluminum alloy is excellent in strength and can be made thinner. The hollow extruded material made of these aluminum alloys is manufactured by appropriately combining temper treatments such as casting (DC casting method or continuous casting method), homogenization heat treatment, hot extrusion, solution treatment and quenching treatment, and artificial aging treatment if necessary. The aluminum extruded material 11 can be reduced in weight by being manufactured by extrusion molding an aluminum alloy.

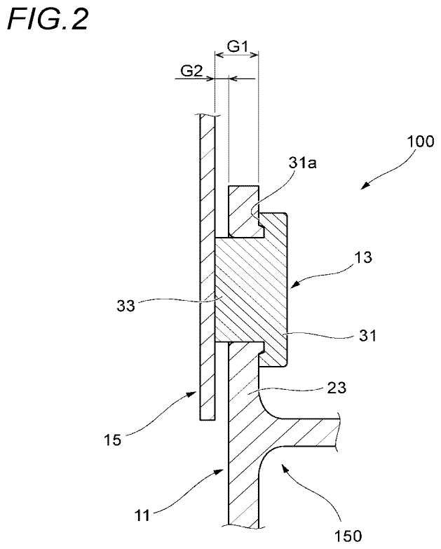

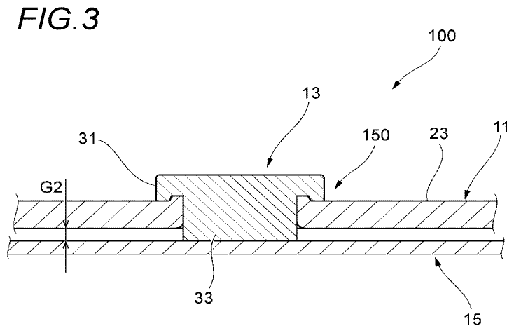

FIG. 2 is a sectional view taken along a direction orthogonal to the longitudinal direction at a joined portion between the flange portion 23 and the steel material 15 of the dissimilar-material joined body 100 according to the first configuration example. FIG. 3 is a sectional view taken along the longitudinal direction at the joined portion between the flange portion 23 and the steel material 15 of the dissimilar-material joined body 100 according to the first configuration example.

As illustrated in FIGS. 2 and 3, the stud member 13 includes a head portion 31 and a shaft portion 33. The head portion 31 has a substantially circular plate shape having a diameter larger than that of the shaft portion 33, and the shaft portion 33 has a substantially cylindrical shape protruding in an axial direction from a center of the head portion 31. A tip end of the shaft portion 33 is a flat surface orthogonal to the axial direction.

The shaft portion 33 of the stud member 13 has a shaft length longer than a thickness of the flange portion 23 of the aluminum extruded material 11. The shaft portion 33 penetrates the flange portion 23 in a plate thickness direction and protrudes from the flange portion 23. The stud member 13 is clinched to the aluminum extruded material 11 by plastic flow of the aluminum material into an annular groove 34 formed on a back side surface 31a of the head portion 31.

The steel material 15 is, for example, a steel material such as a rolled thin plate, a thick plate, or a mold steel which is generally widely used in a vehicle body. The steel material 15 in the present example is a steel plate.

The steel material 15 is disposed on a protruding side of the stud member 13 clinched to the aluminum extruded material 11. Then, the steel material 15 and the tip end of the shaft portion 33 of the stud member 13 are spot welded. Accordingly, the dissimilar-material joined body 100 is formed in which the aluminum extruded material 11 and the steel material 15, which are dissimilar metal materials, are joined to each other by the stud member 13. In addition, due to resistance spot welding, high joining strength can be achieved in a short time, and productivity can be improved.

In the dissimilar-material joined body 100, a constant gap G1 is formed between the back side surface 31a of the head portion 31 of the stud member 13 and the steel material 15. The gap G1 is a gap larger than the thickness of the flange portion 23 of the aluminum extruded material 11. Accordingly, a constant gap G2 is formed between the flange portion 23 of the aluminum extruded material 11 and the steel material 15. Dimensions of the gaps G1 and G2 are optional, and can be controlled to desired intervals. That is, the gaps G1 and G2 can be set to constant dimensions regardless of positions, and in a case in which the steel material 15 has a curved surface or the like, the dimensions can be set as designed which change depending on the positions.

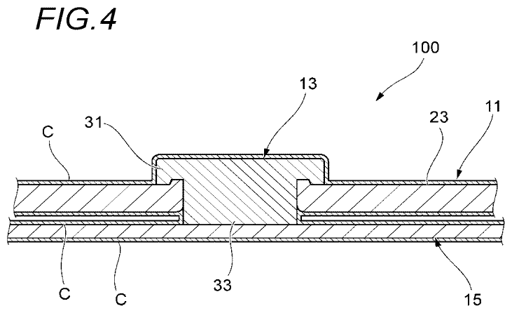

FIG. 4 is a cross sectional view of the joined portion between the flange portion 23 and the steel material 15 of the dissimilar-material joined body 100 to which electrodeposition coating is applied. As illustrated in FIG. 4, when electrodeposition coating is performed on the dissimilar-material joined body 100, a coating film C is formed on an outer surface of the aluminum extruded material 11, an outer surface of the steel material 15, and an outer surface of the head portion 31 of the stud member 13. At this time, since the gap G2 is formed between the flange portion 23 of the aluminum extruded material 11 and the steel material 15, a paint smoothly flows into the gap G2. Accordingly, the coating film C is also satisfactorily formed on a surface of the flange portion 23, a surface of the steel material 15, and an exposed outer peripheral surface of the shaft portion 33 of the stud member 13 which form the gap G2. As the coating film C, for example, a chemical conversion coating film containing trivalent chromate (a trivalent chromium film) or the like is preferable. By using trivalent chromate, cracks are less likely to occur even at a high temperature of, for example, 200° C. or higher, and a decrease in erosion resistance can be prevented.

In the dissimilar-material joined body 100 to which electrodeposition coating is applied, since the electrodeposition coating is uniformly applied, the occurrence of erosion due to penetration of moisture can be effectively prevented. The gap G2 between the flange portion 23 of the aluminum extruded material 11 and the steel material 15 is preferably 0.5 mm to 1.5 mm from a viewpoint of securing fluidity of the paint and securing strength of the dissimilar-material joined body 100.

Next, a method for producing the dissimilar-material joined body 100 will be described.

### (Clinching Step)

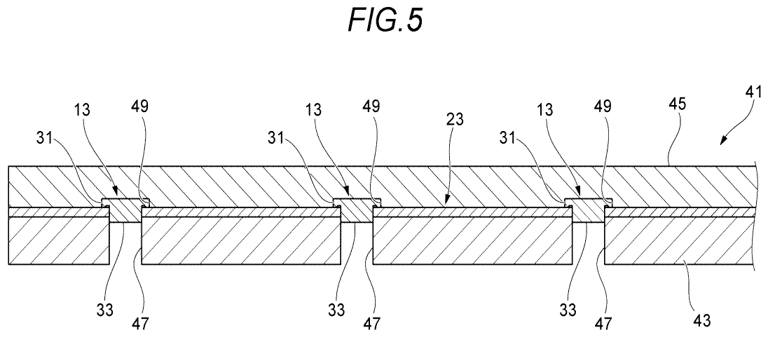

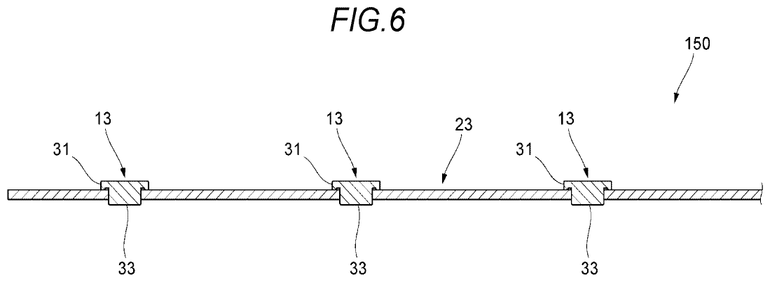

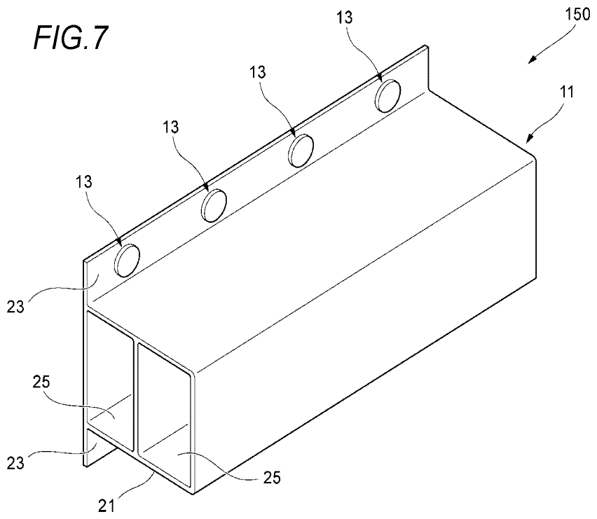

FIG. 5 is a sectional view taken along an arrangement direction of the stud members 13 which illustrates a clinching step of joining the stud members 13 to the flange portion 23. FIG. 6 is a sectional view taken along the arrangement direction of the stud members 13 in the flange portion 23 to which the stud members 13 are joined. FIG. 7 is a perspective view of the aluminum extruded material 11 in which the stud members 13 are clinched to the flange portion 23.

First, the stud members 13 are clinched to the flange portion 23 of the aluminum extruded material 11. When clinching the stud members 13 to the flange portion 23, it is preferable that the plurality of stud members 13 are simultaneously clinched to the flange portion 23.

As illustrated in FIG. 5, a flat die 41 is used for simultaneously clinching the plurality of stud members 13 to the flange portion 23. The flat die 41 includes a female die 43 and a male die 45. The female die 43 is disposed below the male die 45.

The female die 43 has a plurality of hole portions 47, and an upper surface thereof is formed to be flat. The flange portion 23 of the aluminum extruded material 11 is disposed on the upper surface of the female die 43. The male die 45 includes a plurality of holding concave portion 49, and a lower surface thereof is formed to be flat. The holding concave portion 49 has substantially the same depth as the thickness of the head portion 31 of the stud member 13.

In order to clinch the stud member 13 to the flange portion 23 of the aluminum extruded material 11 by the flat die 41, first, the flange portion 23 of the aluminum extruded material 11 is disposed on the upper surface of the female die 43. Next, the head portion 31 of the stud member 13 is fitted into the holding concave portion 49 and is pressed by the held male die 45. Then, the shaft portion 33 of the stud member 13 is driven into the flange portion 23, and a portion of the flange portion 23 corresponding to the shaft portion 33 is punched out by the shaft portion 33 and discharged into the hole portion 47 of the female die 43. Accordingly, as illustrated in FIGS. 6 and 7, the plurality of stud members 13 are simultaneously driven into the flange portion 23 of the aluminum extruded material 11, and the stud-equipped aluminum member 150 is obtained in which the plurality of stud members 13 are clinched to the flange portion 23. The stud member 13 clinched to the flange portion 23 is in a state in which the tip end of the shaft portion 33 penetrates and protrudes from the flange portion 23.

When the stud member 13 is clinched to the flange portion 23 by the flat die 41, the flange portion 23 of the aluminum extruded material 11 is surface-compressed by the upper surface of the female die 43 and the lower surface of the male die 45 around the stud member 13 and between the adjacent stud members 13. That is, a surrounding region in the aluminum extruded material 11, including a space between the stud member 13 and another adjacent stud member 13, is surface-compressed by dies (the female die 43, the male die 45) having flat press surfaces. Accordingly, the flange portion 23 of the aluminum extruded material 11 is restriked (shape corrected by remolding), and flatness can be secured. At the same time as the stud member 13 is driven by the flat die 41, the flange portion 23 can be trimmed into a desired shape, which can reduce the weight.

### (Spot Welding Step)

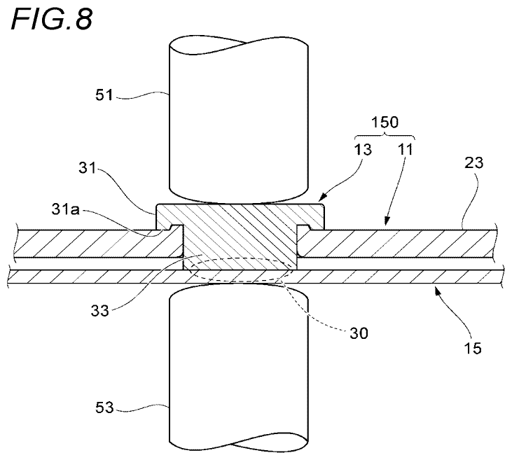

FIG. 8 is a sectional view of a welded portion which illustrates a spot welding step of welding the stud member 13 to the steel material 15.

As illustrated in FIG. 8, the steel material 15 is disposed on the protruding side of the shaft portion 33 of the stud member 13 in the stud-equipped aluminum member 150 in which the clinching of the stud member 13 is completed, and the steel material 15 and the flange portion 23 of the aluminum extruded material 11 are overlapped in the plate thickness direction. Then, a position of the stud member 13 is sandwiched between a pair of welding electrodes 51 and 53, and a welding current is applied to the welding electrodes 51 and 53 while pressure is applied by the welding electrodes 51 and 53. Accordingly, the tip end of the shaft portion 33 of the stud member 13 and the steel material 15 are spot welded to each other in a manner that an interval between the back side surface 31a of the head portion 31 of the stud member 13 and the steel material 15 is constant.

Then, a nugget (a molten portion of the resistance spot welding) 30 is formed between the shaft portion 33 and the steel material 15, and the aluminum extruded material 11 and the steel material 15, which are dissimilar metal materials, are joined to each other by the stud member 13. Accordingly, the dissimilar-material joined body 100 is obtained in which the constant gap G2 is formed between the flange portion 23 of the aluminum extruded material 11 and the steel material 15. In this step, the stud-equipped aluminum member 150 in which the aluminum extruded material 11 and the stud member 13 are integrally joined to each other is joined to the steel material 15. Accordingly, handleability of the aluminum extruded material 11 is improved, and workability of being joined to the steel material is improved.

As described above, according to the dissimilar-material joined body 100 of the present configuration example, the stud member 13 is joined to the flange portion 23 of the aluminum extruded material 11 by clinching and then spot welded to the steel material 15, whereby it is possible to secure the constant gap G2 which allows the paint for electrodeposition coating to flow between the flange portion 23 and the steel material 15.

Since a constant distance can be dimensioned and secured by the back side surface 31a of the head portion 31 of the stud member 13 and the steel material 15, the gap G2 can be secured with high accuracy even if the thickness of the flange portion 23 of the aluminum extruded material 11 varies. As described above, since joining can be performed while accurately maintaining the constant gap G2 between the steel material 15 and the flange portion 23 of the aluminum extruded material 11, the paint for electrodeposition coating can be caused to flow into uniformly. Accordingly, the penetration of moisture into the joined portion can be sufficiently prevented after the electrodeposition coating is performed, and the occurrence of erosion can be effectively prevented.

Further, since the tip end of the shaft portion 33 is flat, the stud member 13 can be prevented from falling down when the stud member 13 is driven into and clinched to the flange portion 23.

Next, another configuration example will be described.

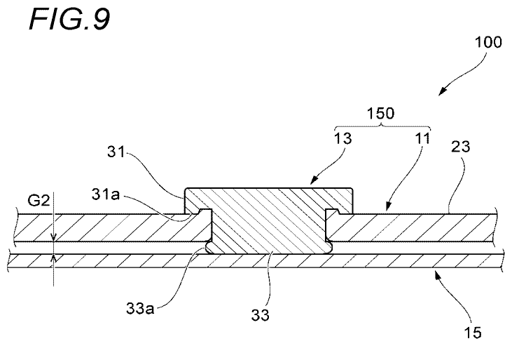

In a configuration example illustrated in FIG. 9, the steel material 15 has a strength higher than a strength of the stud member 13, and the tip end of the shaft portion 33 of the stud member 13 includes an expanded diameter bulging portion 33a that bulges into the gap G2. As the steel material 15, for example, a high-strength steel material (high-tensile steel) containing silicon (Si) or manganese (Mn) is used.

In order to form the expanded diameter bulging portion 33a according to this configuration example, the steel material 15 having a strength higher than the strength of the stud member 13 is disposed on the protruding side of the shaft portion 33 of the stud member 13, and the shaft portion 33 of the stud member 13 is axially compressed during spot welding. Accordingly, the tip end portion of the shaft portion 33 of the stud member 13 is caused to be softened by heat around a resistance heating weld (nugget), and the tip end portion is caused to expand in diameter and to bulge into the gap G2.

According to this configuration example, by forming the expanded diameter bulging portion 33a at the tip end of the stud member 13 in the gap G2, an effect of preventing pulling out when a push out load is applied is further improved.

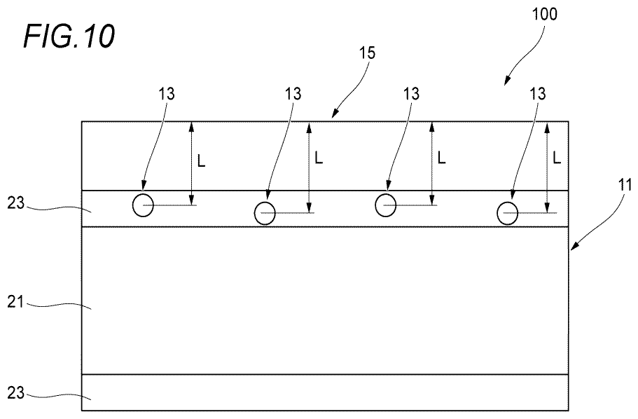

In a configuration example illustrated in FIG. 10, the stud members 13 are disposed in a staggered manner on the flange portion 23 of the aluminum extruded material 11 in a plan view. That is, the stud members 13 are disposed in a manner that distances L from an edge portion of the flange portion 23 are different from each other.

According to this configuration example, since driven portions are dispersed in a direction intersecting the arrangement direction of the stud members 13, deformation of the flange portion 23 when an external force is applied can be prevented. In addition, since the joined portions to the steel material 15 are also dispersed in the direction intersecting the arrangement direction of the stud members 13, the flatness of the flange portion 23 and the steel material 15 is easily maintained.

### Second Configuration Example

Next, a dissimilar-material joined body according to a second configuration example will be described.

The same components as those in the first configuration example are denoted by the same reference numerals, and description thereof is omitted.

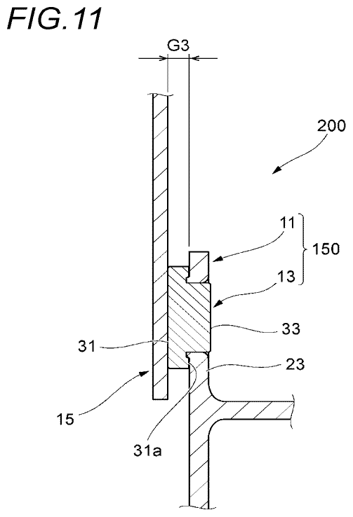

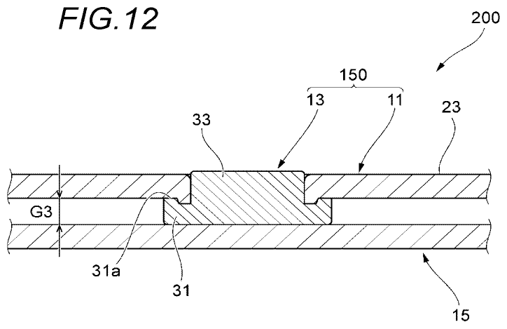

FIG. 11 is a sectional view taken along a direction orthogonal to a longitudinal direction at a joined portion between the flange portion 23 and the steel material 15 of a dissimilar-material joined body 200 according to the second configuration example. FIG. 12 is a sectional view taken along the longitudinal direction at the joined portion between the flange portion 23 and the steel material 15 of the dissimilar-material joined body 200 according to the second configuration example.

As illustrated in FIGS. 11 and 12, in the dissimilar-material joined body 200 according to the second configuration example, the stud member 13 is clinched to the flange portion 23 of the aluminum extruded material 11 in a state in which the shaft portion 33 penetrates and protrudes from an opposite side.

The steel material 15 is disposed on the head portion 31 side of the stud member 13 clinched to the aluminum extruded material 11. Then, the steel material 15 and the head portion 31 of the stud member 13 are abutted and spot welded. Accordingly, the dissimilar-material joined body 200 is obtained in which the aluminum extruded material 11 and the steel material 15, which are dissimilar metal materials, are joined to each other by the stud member 13.

The coating film C is also formed uniformly and satisfactorily on an outer peripheral surface of the head portion 31 of the stud member 13, and occurrence of erosion due to penetration of moisture can be effectively prevented. A gap G3 between the flange portion 23 of the aluminum extruded material 11 and the steel material 15 is also preferably set to 0.5 mm to 1.5 mm from a viewpoint of securing fluidity of the paint and securing strength of the dissimilar-material joined body 200.

When producing the dissimilar-material joined body 200, the stud member 13 is first clinched to the flange portion 23 of the aluminum extruded material 11 by the flat die 41 including the female die 43 and the male die 45 (see FIG. 5). At this time, with respect to the female die 43, the flange portion 23 of the aluminum extruded material 11 is disposed in a direction opposite to that in the case of producing the dissimilar-material joined body 100.

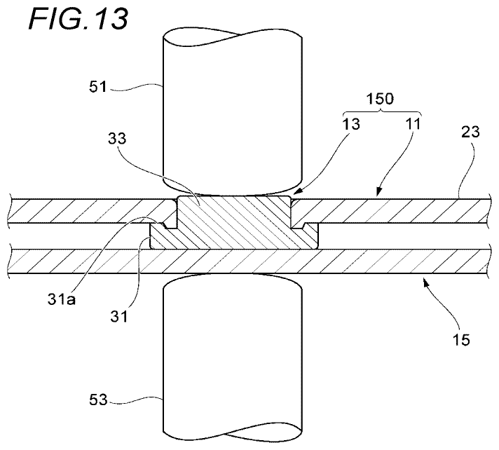

Next, as illustrated in FIG. 13, the steel material 15 is disposed on the head portion 31 side of the stud member 13, and the steel material 15 and the flange portion 23 of the aluminum extruded material 11 are overlapped in the plate thickness direction. Then, a position of the stud member 13 is sandwiched between the pair of welding electrodes 51 and 53, and a welding current is applied to the welding electrodes 51 and 53. Accordingly, the head portion 31 of the stud member 13 and the steel material 15 are spot welded.

Then, the dissimilar-material joined body 200 is obtained in which the aluminum extruded material 11 and the steel material 15, which are dissimilar-material joined bodies, are joined to each other by the stud member 13, and the constant gap G3 is formed between the flange portion 23 of the aluminum extruded material 11 and the steel material 15 by the head portion 31 of the stud member 13. Since a height of the head portion 31 is generally set to a standard dimension, the gap G3 can be formed with high accuracy. When it is desired to make the gap G3 different for each place, the stud member 13 including the head portion 31 having the corresponding height may be selected.

As described above, according to the dissimilar-material joined body 200 of the present configuration example, the stud member 13 is joined to the flange portion 23 of the aluminum extruded material 11 by clinching and then spot welded to the steel material 15, whereby it is possible to secure the constant gap G3 which allows the paint to flow between the flange portion 23 and the steel material 15.

Since a desired distance such as a constant distance can be dimensioned and secured by the head portion 31 of the stud member 13, the gap G3 can be secured with high accuracy even if the thickness of the flange portion 23 of the aluminum extruded material 11 varies. As described above, since joining can be performed while accurately maintaining the gap G3 having a desired interval between the steel material 15 and the flange portion 23 of the aluminum extruded material 11, the paint can be caused to flow into uniformly. Accordingly, the penetration of moisture into the joined portion can be sufficiently prevented after electrodeposition coating is performed, and the occurrence of erosion can be effectively prevented.

According to the present configuration, the gap G3 can be formed with high dimensional accuracy particularly by the head portion 31 of the stud member 13.

Also in the case of the dissimilar-material joined body 200 according to the second configuration example, it is preferable that the stud members 13 are arranged in a staggered manner on the flange portion 23 of the aluminum extruded material 11 in a plan view. As described above, when the stud members 13 are arranged in a staggered manner, the driven portions can be dispersed in a direction intersecting the arrangement direction of the stud members 13, and deformation of the flange portion 23 due to an external force can be prevented. In addition, since the joined portions to the steel material 15 are also dispersed in the direction intersecting the arrangement direction of the stud members 13, the flatness of the flange portion 23 and the steel material 15 can be maintained.

### Another Configuration Example

Next, another configuration example will be described.

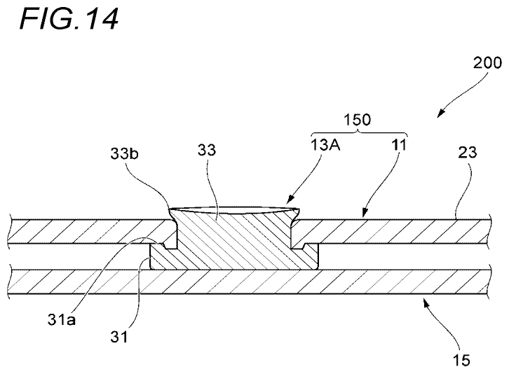

In a configuration example illustrated in FIG. 14, an expanded diameter portion 33b that expands radially outward is formed at a tip end of the shaft portion 33 of a stud member 13A. Accordingly, the flange portion 23 of the aluminum extruded material 11 is engaged with the expanded diameter portion 33b of the stud member 13A.

According to this configuration example, since the expanded diameter portion 33b is formed at the tip end of the shaft portion 33 of the stud member 13A, the flange portion 23 of the aluminum extruded material 11 is engaged with the expanded diameter portion 33b of the stud member 13 even when a push out load is applied, and an effect of preventing pulling out is improved.

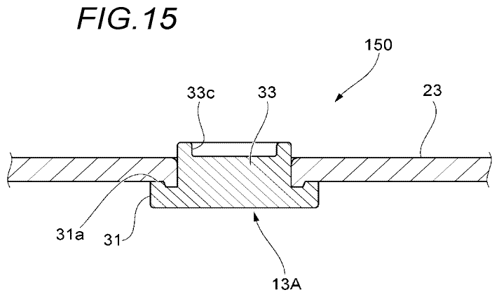

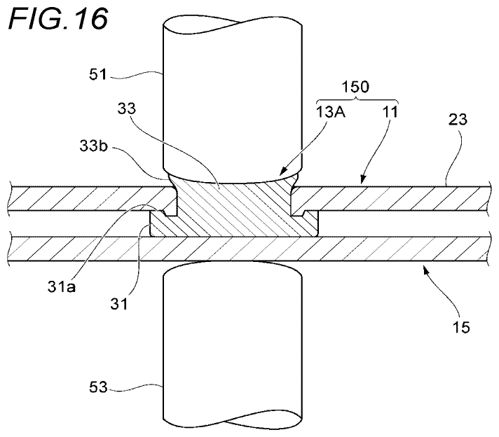

In order to form the expanded diameter portion 33b in this configuration example, as illustrated in FIG. 15, it is preferable to use the stud member 13A in which a concave portion 33c recessed axially inward is formed at the tip end of the shaft portion 33. Due to the concave portion 33c, a thin annular protrusion portion is formed on an outer periphery of the tip end of the shaft portion 33. Then, as illustrated in FIG. 16, a position of the stud member 13A is held between the pair of welding electrodes 51 and 53, and a welding current is applied to the welding electrodes 51 and 53 while pressure is applied by the welding electrodes 51 and 53. During the spot welding, the annular protrusion portion formed by the concave portion 33c at the tip end of the shaft portion 33 of the stud member 13A is expanded by the welding electrode 51, thereby forming the expanded diameter portion 33b.

By providing the concave portion 33c at the tip end of the shaft portion 33 of the stud member 13A in this manner, the tip end of the stud member 13A can be easily expanded radially outward by resistance heating and pressure during spot welding. As the welding electrode 51 on the tip end side of the shaft portion 33, an electrode having a tip end shape of an R shape is preferably used, and this allows the outer ring portion of the concave portion 33c to easily expand in diameter. Further, the stud member 13A is reduced in weight due to the concave portion 33c.

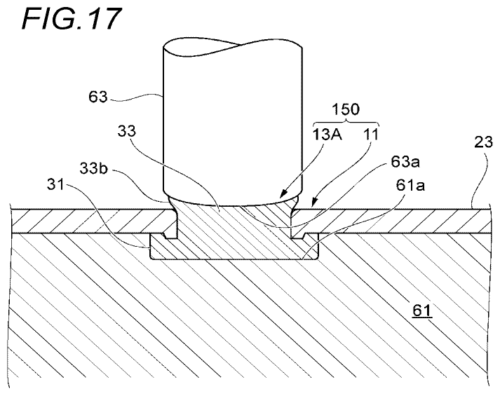

Alternatively, as illustrated in FIG. 17, the expanded diameter portion 33b may be formed by a pressing step (cold pressing) in which a die 61 and a punch 63 are used. A concave portion 61a for accommodating the head portion 31 of the stud member 13A is formed in the die 61, and a curved surface protruding axially outward is formed on a tip end surface 63a of the punch 63. In the stud member 13A, the shaft portion 33 penetrates the aluminum extruded material 11, and the head portion 31 is disposed in the concave portion 61a of the die 61. Then, the punch 63 is moved toward the die 61 by a pressure mechanism (not illustrated) to compress the stud member 13A in the axial direction of the shaft portion 33. Accordingly, the expanded diameter portion 33b bulging radially outward is formed at the tip end of the shaft portion 33.

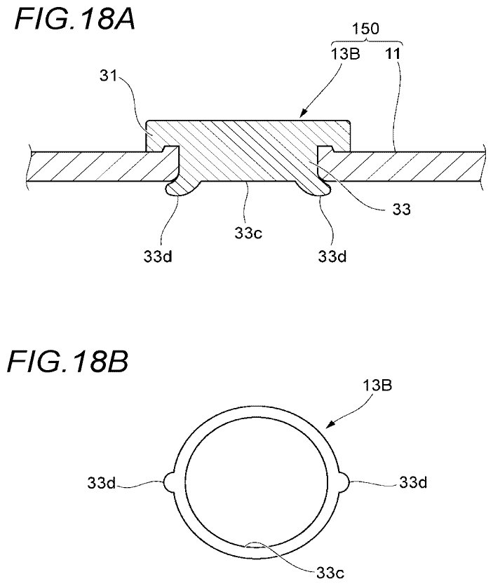

Further, as illustrated in FIG. 18A, a protruding piece 33d may be formed at a part of a tip end of the shaft portion 33 of a stud member 13B including the concave portion 33c. FIG. 18B is a plan view of the stud member 13B illustrated in FIG. 18A as viewed from below. The protruding piece 33d is formed by deforming a part of an annular protrusion portion formed by the concave portion 33c at the tip end of the shaft portion 33.

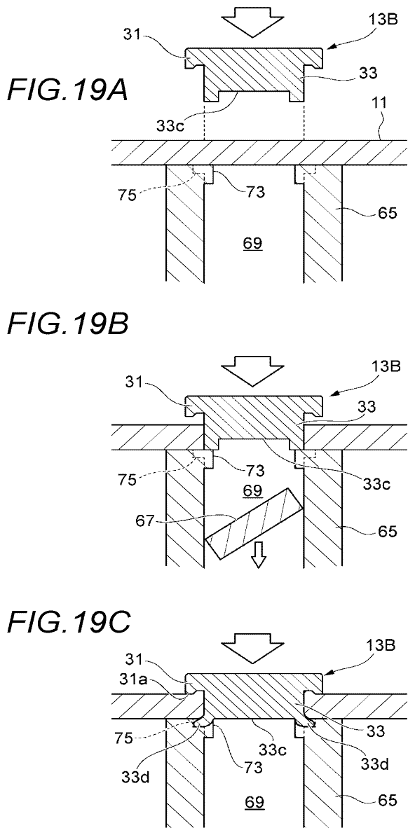

FIGS. 19A to 19C are views each illustrating a forming procedure of the protruding piece 33d. As illustrated in FIG. 19A, the aluminum extruded material 11 is disposed above a die 65, and the stud member 13B including the concave portion 33c is pressed against the aluminum extruded material 11 by a pressing mechanism (not illustrated). Then, as illustrated in FIG. 19B, the aluminum extruded material 11 is punched out by the shaft portion 33 of the stud member 13B. A punched blank 67 is discharged through an inner space 69 of the die 65.

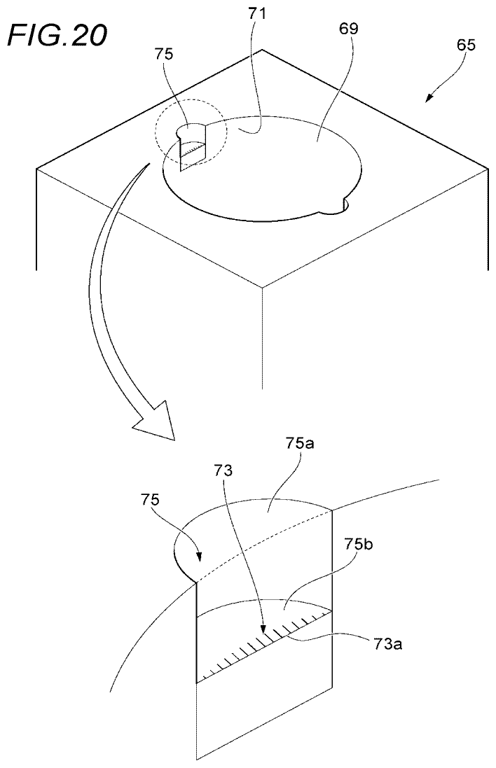

FIG. 20 is a view illustrating a groove structure formed in an upper portion of the die 65 illustrated in FIGS. 19A to 19C. An opening 71 having an inner diameter slightly larger than that of an outer peripheral surface of the shaft portion 33 of the stud member 13B is formed in the upper portion of the die 65, and convex portions 73 each protruding radially inward from an inner peripheral surface of the opening and concave portions 75 each recessed radially outward are formed in a part of the opening. The convex portion 73 is also a groove bottom surface of the concave portion 75, and an edge portion 73a on the radially inner side thereof is linear. That is, the convex portion 73 has a linear edge portion 73a connecting two points on the inner peripheral surface of the opening 71 in a horizontal section of the opening 71, and the edge portion 73a protrudes radially inward. The concave portion 75 has an inner wall surface 75a having a curved horizontal section on the radially outer side of the opening 71, and a bottom surface 75b including the convex portion 73. The convex portion 73 and the concave portion 75 are provided at two points which equally divide a central angle of the opening 71, whereas the convex portion 73 and the concave portion 75 may be provided at a plurality of positions which equally divide the central angle into N portions (N is an integer).

As illustrated in FIG. 19B, when the blank 67 is punched out, the tip end of the shaft portion 33 of the stud member 13 abuts on the convex portion 73. Then, as illustrated in FIG. 19C, when the stud member 13 is further pushed into the aluminum extruded material 11, the back side surface 31a of the head portion 31 is clinched to the aluminum extruded material 11. Then, the thin annular protrusion portion formed at the tip end of the shaft portion 33 is pressed against the convex portion 73 and deformed, and is pushed into the concave portion 75 due to plastic flow, whereby the protruding piece 33d is formed. Accordingly, the aluminum extruded material 11 is sandwiched in the plate thickness direction between the protruding piece 33d protruding radially outward as compared with the shaft portion 33 illustrated in FIGS. 18A and 18B and the head portion 31.

Next, another example of fusion weld for joining the stud member 13 and the steel material 15 will be described.

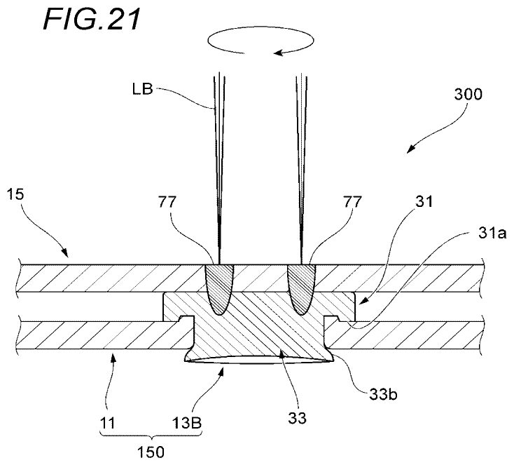

FIG. 21 is a sectional view illustrating a step of laser welding the stud member 13B and the steel material 15. In this case, the steel material 15 is overlapped on the head portion 31 of the stud member 13B, and laser light LB is emitted from a side of the steel material 15 opposite to the stud member 13B side. The laser light LB is emitted from various laser light sources (not illustrated) such as a CO₂ laser, a YAG laser, a fiber laser, and a disk laser, and performs scanning in, for example, a circular shape by beam wobbling. Accordingly, a dissimilar-material joined body 300 is obtained in which the steel material 15 and the head portion 31 of the stud member 13B are joined to each other by a circular molten solidified portion (a laser welding bead) 77. According to laser welding, joining with a high degree of freedom can be easily achieved.

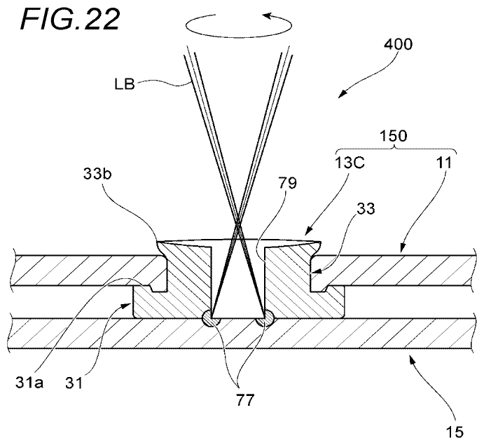

FIG. 22 is a sectional view illustrating a step of laser welding a stud member 13C having a through hole and the steel material 15. In this case, by using the stud member 13C in which a through hole 79 penetrating in the axial direction is formed, a joined position between the head portion 31 and the steel material 15 can be irradiated with the laser light LB through the through hole 79. Also in this case, a dissimilar-material joined body 400 is obtained in which the steel material 15 and the head portion 31 of the stud member 13C are joined to each other by a circular molten solidified portion 77.

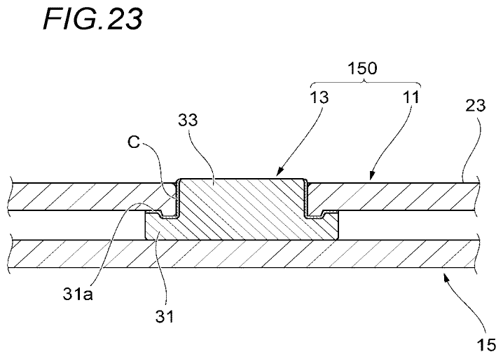

FIG. 23 is a sectional view illustrating an electrodeposition coating region when the head portion 31 of the stud member 13 is joined to the steel material 15. For the stud member 13, when the coating film C is applied to the entire surface of the stud member 13, a coating film forming step can be simplified, whereas during resistance spot welding, the electrical insulating properties of coating film C make it difficult to form a good nugget. As illustrated in FIG. 23, it is preferable to form the coating film C only on the outer periphery of the shaft portion 33 and the back side surface 31a of the head portion 31, which serve as a joining interface with the aluminum extruded material 11.

### <Projection-Equipped Stud Member>

In order to secure conductivity during resistance spot welding while forming a coating film on the entire surface of the stud member, it is useful to provide a projection.

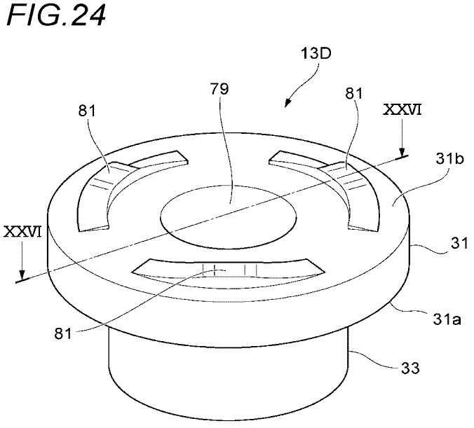

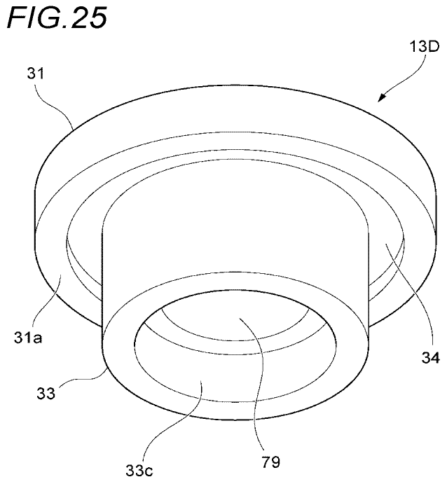

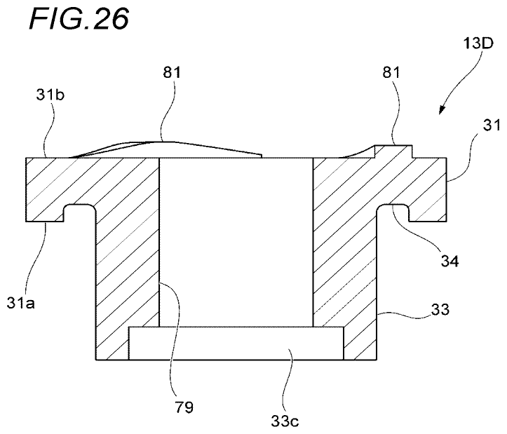

FIG. 24 is a perspective view of a stud member 13D including projections 81 as viewed from a head portion side. FIG. 25 is a perspective view of the stud member 13D illustrated in FIG. 24 as viewed from a shaft portion side. FIG. 26 is a sectional view of the stud member 13D taken along line XXVI-XXVI in FIG. 24. The stud member 13D includes a plurality of projections 81 on a front side surface 31b of the head portion 31 opposite to the shaft portion 33 side. The through hole 79 penetrating in the axial direction is formed in the head portion 31 and the shaft portion 33. The projections 81 are provided at equal intervals along a circumferential direction of the annular front side surface 31b of the head portion 31, and each have an apexes that protrudes at a maximum height.

According to the stud member 13D including the projection 81, a welding current during resistance spot welding is concentrated by the projection 81, and an insulating film on a joining interface with the steel material is broken. As a result, a nugget having a good size is formed. The projection 81 melts and disappears during resistance spot welding, and the resulting molten portion becomes a starting point from which a nugget grows in a circumferential direction and a depth direction, whereby the joining strength is reliably improved. Further, since the projections 81 are arranged uniformly in the circumferential direction, deviation in the circumferential direction of the formed nugget is prevented. The number of the projections 81 is not particularly limited, but is preferably three in order to stabilize a contact posture with a joining partner.

In the stud member 13D having the present configuration, the projections 81 are discretely disposed along the circumferential direction on the front side surface 31b of the head portion 31, but the projection 81 may be a ring-shaped protrusion that is continuous in the circumferential direction. In this case, a joining area with the joining partner can be increased, which makes it easier to form a uniform nugget along the circumferential direction.

As described above, by providing the projection 81 on the stud member 13D, a formation position of the nugget is fixed, and the stability and robustness of the joining strength can be improved. In addition, a large nugget is easily formed even with a constant current, and joining excellent in power saving becomes possible.

Further, since the stud member 13D has the through hole 79, the weight can be reduced. The through hole 79 can also be used for positioning during joining of the stud member 13D.

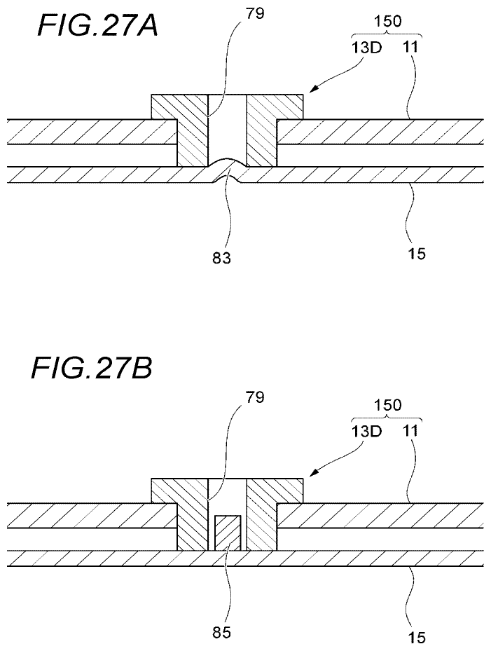

FIG. 27A is a sectional view illustrating a state in which the stud member 13D is positioned at an emboss 83 of the steel material 15. FIG. 27B is a sectional view illustrating a state in which the stud member 13D is positioned on a protrusion 85 provided on the steel material 15.

As illustrated in FIG. 27A, by forming the emboss 83 in the steel material 15, the through hole 79 of the stud member 13D can be positioned in a convex portion of the emboss 83. Accordingly, the stud member 13D can be accurately disposed at the position of the emboss 83. Further, as illustrated in FIG. 27B, by providing the protrusion 85 made of a pin or a resin material on the steel material 15, the through hole 79 of the stud member 13D can be positioned on the protrusion 85. Accordingly, the stud member 13D can be accurately disposed at the position of the protrusion 85. As a result, the stud member 13D can be joined to a desired position on the steel material 15 with higher positional accuracy.

Further, the through hole 79 of the stud member 13B can be used as an insertion port for a probe for non-destructive inspection. For example, a probe including a search coil at a tip end thereof may be inserted into the through hole 79 to inspect quality of the joint between the steel material 15 and the stud member 13B. Alternatively, ultrasonic vibration may be applied to the steel material 15, and the surface of the steel material 15 may be irradiated with laser light through the through hole 79, and the inspection may be performed by an ultrasonic optical flaw detection method, which detects cavities, gaps, scratches, and the like from signals obtained from reflection of the laser light.

### Configuration Examples of Other Stud Members

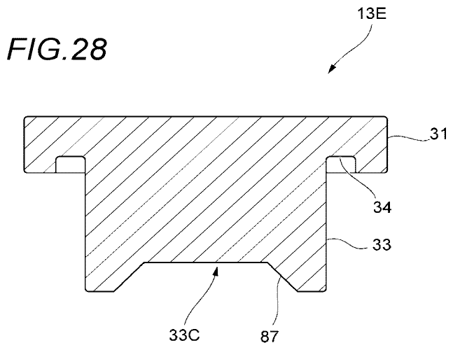

FIG. 28 is a sectional view of a stud member having another configuration. A stud member 13E includes the concave portion 33c at the tip end of the shaft portion 33. The concave portion 33c has a tapered inner peripheral surface 87 whose diameter expands toward the tip end of the shaft portion 33. Due to the tapered inner peripheral surface 87, an annular protrusion portion which is thicker on a base end side and thinner towards a tip end side is formed at the tip end of the shaft portion 33. Other configurations are the same as those of the stud member 13A illustrated in FIG. 15.

According to the stud member 13E having the present configuration, in a case in which an expanded diameter portion in which the diameter of the tip end of the shaft portion 33 expands radially outward is formed by resistance spot welding or cold pressing, a volume of the expanded diameter portion is increased, and an engagement strength with the flange portion 23 of the aluminum extruded material 11 described above (FIG. 14) can be improved. A flare shape of the expanded diameter portion can be stabilized. Further, during resistance spot welding, a contact area between the steel material (not illustrated) which is a joining partner and the annular protrusion portion becomes small, which results in an effect of stabilizing a formation position of the nugget.

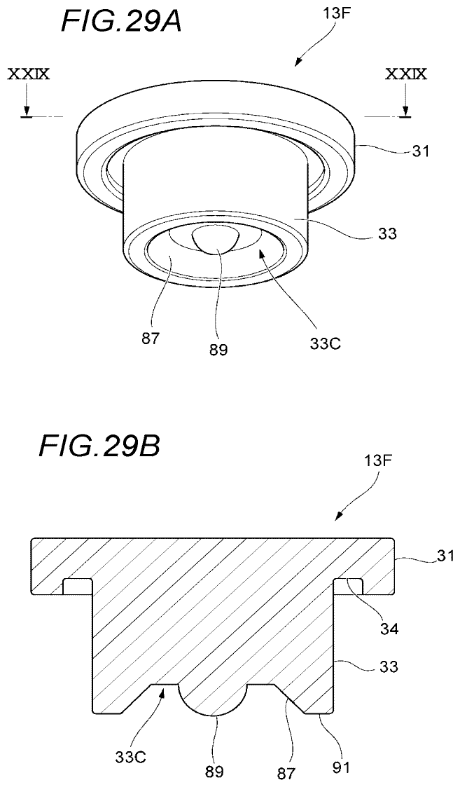

FIG. 29A is a perspective view of a stud member 13F in which a protruding portion 89 protruding axially is provided in the concave portion 33c at the tip end of the shaft portion 33. FIG. 29B is a sectional view of the stud member 13F taken along line XXIX-IX XXIX in FIG. 29A. The stud member 13F has the same configuration as that of the stud member 13E except that the protruding portion 89 having a tip end surface formed of a curved surface (for example, a spherical surface) having a predetermined curvature radius is provided in the concave portion 33c of the stud member 13E. The protruding portion 89 protrudes along a central axis of the shaft portion 33, and a tip end thereof has the same height as or substantially the same height as a tip end surface 91 of the outer periphery of the shaft portion 33.

According to the stud member 13F having the present configuration, since the protruding portion 89 is formed on an inner side of the concave portion 33c, in a case in which the diameter of the tip end of the shaft portion 33 is caused to expand radially outward due to resistance spot welding or cold pressing, a volume (a thickness, an expanded diameter length) of the portion whose diameter is caused to expand is further increased, and the engagement strength with the flange portion 23 of the aluminum extruded material 11 described above (FIG. 14) can be improved. During resistance spot welding, the protruding portion 89 comes into contact with a steel material (not illustrated) which is a joining partner, and a posture of the stud member 13F can be further stabilized. By providing the protruding portion 89, welding current concentrates, and a large nugget can be easily formed with which high joining strength can be achieved.

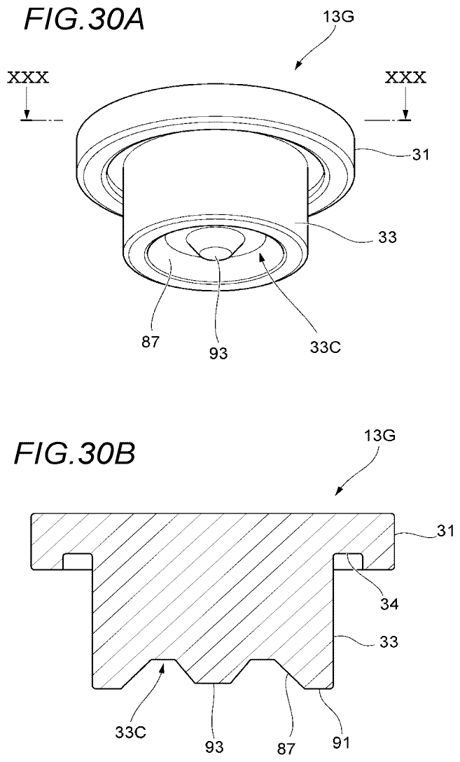

FIG. 30A is a perspective view of a stud member 13G in which a protruding portion 93 protruding axially is provided in the concave portion 33c at the tip end of the shaft portion 33. FIG. 30B is a sectional view of the stud member 13G taken along line XXX-XXX in FIG. 30A. The stud member 13G has the same configuration as that of the stud member 13F except that the tip end of the protruding portion 89 of the stud member 13F has a flat surface. The protruding portion 93 has a truncated cone shape protruding along the central axis of the shaft portion 33, and a tip end surface thereof has the same height as or substantially the same height as the tip end surface 91 of the outer periphery of the shaft portion 33.

According to the stud member 13G having the present configuration, since the protruding portion 93 is formed on the inner side of the concave portion 33c, as described above, the volume of the expanded diameter portion obtained by causing the diameter of the tip end of the shaft portion 33 to expand radially outward is further increased, and the engagement strength with the flange portion 23 of the aluminum extruded material 11 described above (FIG. 14) can be improved. During resistance spot welding, a steel material (not illustrated) which is a joining partner and the protruding portion 93 come into surface contact with each other, and during cold pressing, the die and the protruding portion 93 come into surface contact with each other, and thus a posture of the stud member 13G can be further stabilized. By providing the protruding portion 93, a large nugget can be easily formed with which high joining strength can be achieved.

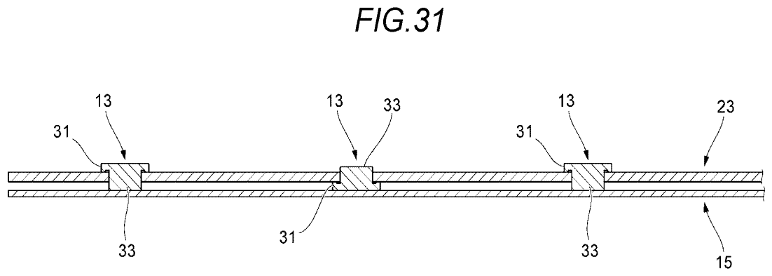

When joining the various stud members described above to the steel material 15, the stud members to be joined to the steel material 15 may be oriented in a manner that a portion where the shaft portion 33 side is joined to the steel material 15 and a portion where the head portion 31 side is joined to the steel material are mixed. Specifically, as illustrated in FIG. 31, the stud member 13 may be driven into the flange portion 23 of the aluminum extruded material 11 in different directions, and spot welding may be performed between the shaft portion 33 and the steel material 15 and between the head portion 31 and the steel material 15. In this way, it is possible to achieve both the improvement in an effect of preventing push out by the engagement of the head portion 31 with the flange portion 23 and the securing of the stable gap between the steel material 15 and the flange portion 23 by the head portion 31.

As described above, the present invention is not limited to the above-described embodiments, and combinations of the respective configurations of the embodiments and changes and applications made by those skilled in the art based on the description of the specification and common techniques are also intended for the present invention and are included in the scope of protection.

For example, although the aluminum extruded material is exemplified as the aluminum material, the aluminum material is not limited thereto, and may be a plate shape material made of an aluminum plate material, an aluminum casting, an wrought aluminum alloy, or the like.

The expanded diameter portion 33b (FIG. 14), (the expanded diameter bulging portion 33a (FIG. 9), and the protruding piece 33d (FIGS. 18A and 18B) formed at the tip end of the shaft portion of the stud member described above are preferably formed to be the same as or exceed a maximum radial distance of the annular groove 34 (see FIG. 28) formed on the back side surface of the head portion 31 of the stud member, and extend to a region equal to or less than a radial distance of the head portion 31. The expanded diameter portion 33b, the expanded diameter bulging portion 33a, and the protruding piece 33d extending radially outward side may be formed in any form, such as formed in at least one portion or a plurality of portions or in a continuous annular shape along the circumferential direction of the shaft portion 33.

As described above, the present specification discloses the following matters.
(1) A dissimilar-material joined body, which is obtained by fusion joining a steel material and a stud-equipped aluminum member obtained by attaching a steel stud member to an aluminum material, in which
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material, and
the head portion and the steel material are fusion welded to each other with a gap having a desired interval formed between the aluminum material and the steel material.

According to this dissimilar-material joined body, the shaft portion of the stud member penetrates the aluminum material to form the expanded diameter portion, and the head portion of the stud member and the steel material are fusion welded, whereby a desired gap can be secured between the aluminum material and the steel material. A paint for electrodeposition coating can be caused to flow into the gap. A desired interval can be secured by the expanded diameter portion of the stud member, and thus the gap can be secured with high accuracy even when the thickness of the aluminum material varies. In this way, the steel material and the aluminum material can be joined to each other via the stud member while maintaining the gap with high accuracy, and thus the paint can be caused to flow into the gap uniformly. Accordingly, the penetration of moisture into the joined portion can be prevented after the electrodeposition coating is performed, and the occurrence of erosion can be effectively prevented. In addition, since the tip end of the shaft portion of the stud member expands due to the expanded diameter portion, the aluminum material is engaged with the expanded diameter portion even when a push out load is applied, and the effect of preventing pulling out is improved.
(2) The dissimilar-material joined body according to (1), in which the stud member is formed with a through hole penetrating the head portion and the shaft portion along an axial direction of the shaft portion.

According to this dissimilar-material joined body, since the through hole is formed in the stud member, the joined portion between the stud member and the steel material can be observed through the through hole. Accordingly, for example, a probe for non-destructive inspection can be inserted into the through hole, and reflected light can be extracted by the ultrasonic optical flaw detection method, and thus the reliability of the inspection can be improved.
(3) A dissimilar-material joined body, which is obtained by fusion joining a steel material and a stud-equipped aluminum member obtained by attaching a steel stud member to an aluminum material, in which
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material, and
the tip end of the shaft portion and the steel material are fusion welded to each other with a gap having a desired interval formed between the aluminum material and the steel material.

According to this dissimilar-material joined body, a desired gap can be secured between the aluminum material and the steel material by fusion welding the steel material and the expanded diameter portion which is formed by the shaft portion of the stud member that penetrates the aluminum material. A paint for electrodeposition coating can be caused to flow into the gap. A desired interval can be secured by the expanded diameter portion of the stud member, and thus the gap can be secured with high accuracy even when the thickness of the aluminum material varies. In this way, the steel material and the aluminum material can be joined to each other via the stud member while maintaining the gap with high accuracy, and thus the paint can be caused to flow into the gap uniformly. Accordingly, the penetration of moisture into the joined portion can be prevented after the electrodeposition coating is performed, and the occurrence of erosion can be effectively prevented. In addition, since the tip end of the shaft portion of the stud member expands due to the expanded diameter portion, the aluminum material is engaged with the expanded diameter portion even when a push out load is applied, and the effect of preventing pulling out is improved.
(4) The dissimilar-material joined body according to any one of (1) to (3), in which the gap is 0.5 mm to 1.5 mm.

According to this dissimilar-material joined body, the strength of the dissimilar-material joined body can be secured while the fluidity of the paint is secured.
(5) The dissimilar-material joined body according to any one of (1) to (4), in which a chemical conversion coating film including a trivalent chromium film is formed on at least a contact surface of the stud member with the aluminum material.

According to this dissimilar-material joined body, electric erosion between dissimilar materials can be prevented by the chemical conversion coating film. In particular, by including the trivalent chromium film, cracks are less likely to occur even at a high temperature, and a decrease in erosion resistance can be prevented.
(6) The dissimilar-material joined body according to any one of (1) to (5), in which a weld formed by the fusion welding is a nugget.

According to this dissimilar-material joined body, higher joining strength can be achieved in a short time by resistance spot welding.
(7) The dissimilar-material joined body according to any one of (1) to (6), in which a weld formed by the fusion welding is an annular bead.

According to this dissimilar-material joined body, joining with a higher degree of freedom can be easily achieved by laser welding.
(8) The dissimilar-material joined body according to any one of (1) to (7), in which the stud members are arranged in a staggered manner in a plan view of the aluminum material.

According to this dissimilar-material joined body, deformation of the aluminum material when an external force is applied can be prevented. In addition, since the joined portions to the steel material are also dispersed in the direction intersecting the arrangement direction of the stud members, the flatness of the aluminum material and the steel material is easily maintained.
(9) The dissimilar-material joined body according to any one of (1) to (8), in which the aluminum material is a plate-shaped flange portion of an aluminum extruded material, the aluminum extruded material including a main body portion having a hollow sectional shape and at least one plate-shaped flange portion protruding outward from the main body portion.

According to this dissimilar-material joined body, a reinforcing material obtained by joining the steel material to the aluminum extruded material can be easily obtained.
(10) A stud-equipped aluminum member, which is obtained by attaching a steel stud member that is to be fusion welded to a steel material to an aluminum material, in which
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material,
a protrusion portion protruding in an axial direction of the shaft portion is provided on a front side surface of the head portion opposite to the shaft portion, and
the head portion and the steel material are fusion welded to each other with a gap having a desired interval formed between the aluminum material and the steel material.

According to this stud-equipped aluminum member, since the stud member is fixed to the aluminum material, the handleability is improved, and the workability of fusion joining with the steel material is improved. In addition, since the tip end of the shaft portion of the stud member expands due to the expanded diameter portion, the aluminum material is engaged with the expanded diameter portion of the stud member even when a push out load is applied, and the effect of preventing pulling out is improved.
(11) The stud-equipped aluminum member according to (10), in which at least three of the protrusion portions are provided on the front side surface of the head portion.

According to this stud-equipped aluminum member, a contact posture of the stud member with a joining partner is stabilized.
(12) The stud-equipped aluminum member according to (10), in which the protrusion portion is annularly provided on the front side surface of the head portion.

According to this stud-equipped aluminum member, uniform fusion welding can be performed due to the annular protrusion portion.
(13) The stud-equipped aluminum member according to any one of (10) to (12), in which the stud member is formed with a through hole penetrating the head portion and the shaft portion along the axial direction of the shaft portion.

According to this stud-equipped aluminum member, since the through hole is formed in the stud member, the joined portion between the stud member and the steel material can be observed through the through hole. Accordingly, for example, a probe for non-destructive inspection can be inserted into the through hole, and reflected light can be extracted by the ultrasonic optical flaw detection method, and thus the reliability of the inspection can be improved.
(14) A stud-equipped aluminum member, which is obtained by attaching a steel stud member that is to be fusion welded to a steel material to an aluminum material, in which
the stud member includes a head portion and a shaft portion,
the shaft portion penetrates the aluminum material in a plate thickness direction and protrudes from the aluminum material,
a back side surface of the head portion that faces the aluminum material is clinched to the aluminum material,
a concave portion recessed axially inward is formed at a tip end of the shaft portion, and
the tip end of the shaft portion and the steel material are fusion welded to each other with a gap having a desired interval formed between the aluminum material and the steel material.

According to this stud-equipped aluminum member, since the concave portion is formed at the tip end of the shaft portion, the weight of the stud member can be reduced.
(15) The stud-equipped aluminum member according to (14), in which the concave portion has a tapered inner peripheral surface whose diameter expands toward the tip end of the shaft portion.

According to this stud-equipped aluminum member, by providing the tapered inner peripheral surface in the concave portion of the shaft portion, it is possible to form the annular protrusion portion which is thicker on the base end side of the tip end of the shaft portion and thinner towards the tip end side of the shaft portion.
(16) The stud-equipped aluminum member according to (14) or (15), in which a protruding portion protruding axially is formed on a bottom portion of the concave portion, and a tip end of the protruding portion is either a flat surface or a curved surface.

According to this stud-equipped aluminum member, by providing the protruding portion protruding from the bottom portion of the concave portion, when the diameter of the tip end of the shaft portion is caused to expand radially outward due to resistance spot welding or cold pressing, the volume (the thickness, the expanded diameter length) of the portion of which the diameter is caused to expand is further increased, and the engagement strength with the aluminum material can be improved.
(17) The stud-equipped aluminum member according to any one of (10) to (16), in which a chemical conversion coating film including a trivalent chromium film is formed on at least a contact surface of the stud member with the aluminum material.

According to this stud-equipped aluminum member, electric erosion between dissimilar materials can be prevented by the chemical conversion coating film. In particular, by including the trivalent chromium film, cracks are less likely to occur even at a high temperature, and a decrease in erosion resistance can be prevented.
(18) A method for producing a dissimilar-material joined body, the dissimilar-material joined body being obtained by joining a steel material and a stud-equipped aluminum member obtained by attaching a steel stud member to an aluminum material, the method including:
driving a shaft portion of the stud member including a head portion and the shaft portion into the aluminum material so that a tip end of the shaft portion penetrates the aluminum material to protrude from the aluminum material, an expanded diameter portion that expands radially outward is formed at the protruding tip end of the shaft portion, and a back side surface of the head portion that faces the aluminum material is clinched to the aluminum material; and
fusion welding the shaft portion and the steel material while overlapping the tip end of the shaft portion and the steel material and forming a gap having a desired interval between the aluminum material and the steel material.

According to this method for producing a dissimilar-material joined body, a desired gap can be secured between the aluminum material and the steel material by clinching the stud member to the aluminum material and fusion welding the stud member and the steel material. A paint for electrodeposition coating can be caused to flow into the gap. A desired interval can be secured by the expanded diameter portion of the stud member, and thus the gap can be secured with high accuracy even when the thickness of the aluminum material varies. In this way, the steel material and the aluminum material can be joined to each other via the stud member while maintaining the gap with high accuracy, and thus the paint can be caused to flow into the gap uniformly. Accordingly, the penetration of moisture into the joined portion can be prevented after the electrodeposition coating is performed, and the occurrence of erosion can be effectively prevented. In addition, since the tip end of the shaft portion of the stud member expands due to the expanded diameter portion, the aluminum material is engaged with the expanded diameter portion even when a push out load is applied, and the effect of preventing pulling out is improved.
(19) The method for producing a dissimilar-material joined body according to (18), in which
the steel material having a strength higher than that of the stud member is used, and,
the method further includes:
compressing the shaft portion axially by performing resistance spot welding while pressing the tip end of the shaft portion of the stud member against the steel material, thereby forming, at the tip end of the shaft portion, an expanded diameter bulging portion bulging radially outward.

According to this method for producing a dissimilar-material joined body, the expanded diameter bulging portion can be formed in the gap between the aluminum material and the steel material, whereby the effect of preventing pulling out when a push out load is applied can be improved.
(20) A method for producing a dissimilar-material joined body, the dissimilar-material joined body being obtained by joining a steel material and a stud-equipped aluminum member obtained by attaching a steel stud member to an aluminum material, the method including:
driving a shaft portion of the stud member including a head portion and the shaft portion into the aluminum material so that a tip end of the shaft portion penetrates the aluminum material in a plate thickness direction to protrude from the aluminum material, an expanded diameter portion that expands radially outward is formed at the protruding tip end of the shaft portion, and a back side surface of the head portion that faces the aluminum material is clinched to the aluminum material; and
fusion welding the head portion and the steel material while overlapping the head portion and the steel material and forming a gap having a desired interval between the aluminum material and the steel material.

According to this method for producing a dissimilar-material joined body, a desired gap can be secured between the aluminum material and the steel material by clinching the stud member to the aluminum material and fusion welding the stud member and the steel material. A paint for electrodeposition coating can be caused to flow into the gap. A desired interval can be secured by the expanded diameter portion of the stud member, and thus the gap can be secured with high accuracy even when the thickness of the aluminum material varies. In this way, the steel material and the aluminum material can be joined to each other via the stud member while maintaining the gap with high accuracy, and thus the paint can be caused to flow into the gap uniformly. Accordingly, the penetration of moisture into the joined portion can be prevented after the electrodeposition coating is performed, and the occurrence of erosion can be effectively prevented. In addition, since the tip end of the shaft portion of the stud member expands due to the expanded diameter portion, the aluminum material is engaged with the expanded diameter portion even when a push out load is applied, and the effect of preventing pulling out is improved.
(21) The method for producing a dissimilar-material joined body according to any one of (18) to (20), in which the fusion welding is resistance spot welding.

According to this method for producing a dissimilar-material joined body, higher joining strength can be achieved in a short time by resistance spot welding.
(22) The method for producing a dissimilar-material joined body according to any one of (18) to (20), in which the fusion welding is laser welding.

According to this method for producing a dissimilar-material joined body, joining with a higher degree of freedom can be easily achieved by laser welding.
(23) The method for producing a dissimilar-material joined body according to any one of (18) to (20), further including: simultaneously with the fusion welding, the stud member is compressed in the axial direction of the shaft portion to cause the tip end of the shaft portion of the stud member to bulge into the gap.

According to this method for producing a dissimilar-material joined body, the tip end of the stud member bulges in the gap between the aluminum material and the steel material, and thus the aluminum material is sandwiched between the head portion of the stud member and the bulging portion. Accordingly, the effect of preventing the stud member from pulling out when a push out load is applied can be improved.
(24) The method for producing a dissimilar-material joined body according to any one of (20) to (23), in which the stud member has an annular thin portion along an outer peripheral surface, the annular thin portion being formed at the tip end of the shaft portion; and the method further including:
after causing the shaft portion to penetrate the aluminum material, overlapping the head portion and the steel material, and performing spot welding by sandwiching the tip end of the shaft portion and the steel material between a pair of spot welding electrodes.

According to this method for producing a dissimilar-material joined body, the diameter of the tip end of the stud member can be easily caused to expand by resistance heating and pressure during spot welding.
(25) The method for producing a dissimilar-material joined body according to any one of (18) to (24), further including:
a step of simultaneously driving a plurality of the stud members into the aluminum material, in which
in the step, a surrounding region in the aluminum material including a space between the stud member and another stud member adjacent to the stud member is surface-compressed by a die having a flat press surface.

According to this method for producing a dissimilar-material joined body, when the stud member is driven, the surrounding region of the stud member in the aluminum material is surface-compressed and restriked by the die. Accordingly, the flatness of the flange portion can be secured.

The present application is based on the Japan patent application (Japanese Patent Application No. 2022-033876) filed on Mar. 4, 2022 and the Japanese patent application (Japanese Patent Application No. 2022-133579) filed on Aug. 24, 2022, and contents of which are incorporated herein by reference.

### REFERENCE SIGNS LIST

11: aluminum extruded material (aluminum material)
13, 13A, 13B, 13C, 13D, 13E, 13F, 13G: stud member
15: steel material
21: main body portion
23: flange portion
25: hollow portion
30: nugget (molten portion of resistance spot welding)
31: head portion
31a: back side surface
31b: front side surface
33: shaft portion
33a: expanded diameter bulging portion
33b: expanded diameter portion
33c: concave portion
33d: protruding piece
34: annular groove
41: flat die
43: female die
45: male die
47: hole portion
49: holding concave portion
51, 53: welding electrode
61: die
61a: concave portion
63: punch
63a: tip end surface
65: die
67: blank
69: inner space
71: opening
73: convex portion
73a: edge portion
75: concave portion
75a: inner wall surface
75b: bottom surface
77: molten solidified portion (bead of laser welding)
79: through hole
81: projection
83: emboss
85: protrusion
87: inner peripheral surface
89: protruding portion
91: tip end surface
93: protruding portion
100, 200, 300, 400: dissimilar-material joined body
150: stud-equipped aluminum member
C: coating film
G1, G2, G3: gap
LB: laser light

1. A dissimilar-material joined body, which is obtained by fusion joining a steel material and a stud-equipped aluminum member obtained by attaching a steel stud member to an aluminum material, wherein
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material, and
the head portion and the steel material are fusion welded to each other with a gap having a desired interval formed between the aluminum material and the steel material.

2. The dissimilar-material joined body according to claim 1, wherein
the stud member is formed with a through hole penetrating the head portion and the shaft portion along an axial direction of the shaft portion.

3. A dissimilar-material joined body, which is obtained by fusion joining a steel material and a stud-equipped aluminum member obtained by attaching a steel stud member to an aluminum material, wherein
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material, and
the tip end of the shaft portion and the steel material are fusion welded to each other with a gap having a desired interval formed between the aluminum material and the steel material.

4. The dissimilar-material joined body according to claim 1, wherein
the gap is 0.5 mm to 1.5 mm.

5. The dissimilar-material joined body according to claim 1, wherein
a chemical conversion coating film including a trivalent chromium film is formed on at least a contact surface of the stud member with the aluminum material.

6. The dissimilar-material joined body according to claim 1, wherein
a weld formed by the fusion welding is a nugget.

7. The dissimilar-material joined body according to claim 1, wherein
a weld formed by the fusion welding is an annular bead.

8. The dissimilar-material joined body according to claim 1, wherein
the stud members are arranged in a staggered manner in a plan view of the aluminum material.

9. The dissimilar-material joined body according to claim 1, wherein
the aluminum material is a plate-shaped flange portion of an aluminum extruded material, the aluminum extruded material including a main body portion having a hollow sectional shape and at least one plate-shaped flange portion protruding outward from the main body portion.

10. A stud-equipped aluminum member obtained by attaching a steel stud member that is to be fusion welded to a steel material, to an aluminum material, wherein
the stud member includes a head portion and a shaft portion,
the shaft portion penetrates the aluminum material in a plate thickness direction to protrude from the aluminum material, and has an expanded diameter portion that expands radially outward at a tip end of the protruding shaft portion,
a back side surface of the head portion that faces the aluminum material is clinched to the aluminum material,
a protrusion portion protruding in an axial direction of the shaft portion is provided on a front side surface of the head portion opposite to the shaft portion, and
the head portion and the steel material are fusion welded to each other with a gap having a desired interval formed between the aluminum material and the steel material.

11. The stud-equipped aluminum member according to claim 10, wherein
at least three of the protrusion portions are provided on the front side surface of the head portion.

12. The stud-equipped aluminum member according to claim 10, wherein
the protrusion portion is annularly provided on the front side surface of the head portion.

13. The stud-equipped aluminum member according to claim 10, wherein
the stud member is formed with a through hole penetrating the head portion and the shaft portion along the axial direction of the shaft portion.

14. A stud-equipped aluminum member obtained by attaching a steel stud member that is to be fusion welded to a steel material, to an aluminum material, wherein
the stud member includes a head portion and a shaft portion,
the shaft portion penetrates the aluminum material in a plate thickness direction and protrudes from the aluminum material,
a back side surface of the head portion that faces the aluminum material is clinched to the aluminum material,
a concave portion recessed axially inward is formed at a tip end of the shaft portion, and
the tip end of the shaft portion and the steel material are fusion welded to each other with a gap having a desired interval formed between the aluminum material and the steel material.

15. The stud-equipped aluminum member according to claim 14, wherein
the concave portion has a tapered inner peripheral surface whose diameter expands toward the tip end of the shaft portion.

16. The stud-equipped aluminum member according to claim 14, wherein
a protruding portion protruding axially is formed on a bottom portion of the concave portion, and a tip end of the protruding portion is either a flat surface or a curved surface.

17. The stud-equipped aluminum member according to claim 10, wherein
a chemical conversion coating film including a trivalent chromium film is formed on at least a contact surface of the stud member with the aluminum material.

18-25. (canceled)
